(19) United States
(12) Patent Application Publication
(10) Pub. No.: US 2026/0302688 A1
(43) Pub. Date: Oct. 1, 2026

(54) Connector system with magnetic alignment module

(71) Applicant: HARTING Electric Stiftung & Co. KG, Espelkamp (DE)

(72) Inventors: Karol GOSZCZYNSKI, Big Rock, IL (US); Casey SPITZ, Arlington Heights, IL (US)

(73) Assignee: HARTING Electric Stiftung & Co. KG, Espelkamp (DE)

(21) Appl. No.: 19/479,798

(22) PCT Filed: Jun. 26, 2024
(86) PCT No.: PCT/EP2024/067950

§ 371 Date: Oct. 29, 2025

Related U.S. Application Data
(60) Provisional application No. 63/523,155, filed on Jun. 26, 2023.

(51) Int. Cl. H01R 13/62; H01R 13/629; H01R 13/631; H01R 13/64

(52) U.S. Cl. CPC H01R 13/6205; H01R 13/62966; H01R 13/631; H01R 13/64

(57) ABSTRACT

An electrical connector system may include a plug connector and a socket connector. The plug connector may include a plurality of pin contacts that are held in a plug insert, and a plug magnet module that includes a plug magnet arranged within a plug magnet insert. The socket connector may include a plurality of receptacle contacts that are held in a socket insert, and a socket magnet module that includes a socket magnet arranged within a socket magnet insert. The plug magnet or the socket magnet may be held in an axially fixed position in its respective magnet insert, while the opposite magnet may be axially slidingly arranged in its respective magnet insert.

### TECHNICAL FIELD

The present disclosure relates to electrical connectors, and more specifically to industrial plug connectors having a magnetic alignment module to aid blind operation.

### BACKGROUND

Plug and socket connectors are usually made up of a male plug and a female socket. The plug typically includes pin contacts, and the socket typically includes receptacle contacts. Sockets are often permanently fixed to a device as in a chassis connector, and plugs are attached to a cable. Plugs and sockets may both be connected to cables, for example to connect two cables to one another.

Plugs generally have one or more metal contacts, also referred to as terminals, which are inserted into openings in the mating socket. The connection between the mating metal parts must be sufficiently tight to make a good electrical connection and complete a circuit.

In some instances, plugs and sockets are located out of sight so that plugging a plug into a socket is a blind operation.

### SUMMARY

In some aspects, the techniques described herein relate to a connector system, including a plug connector and a socket connector. The plug connector includes a plurality of pin contacts. The pin contacts are held in a plug insert. The plug connector further includes a plug magnet module. The plug magnet module includes a plug magnet arranged within a plug magnet insert. The system socket connector is designed to mate with the plug connector. The socket connector includes a plurality of receptacle contacts. The receptacle contacts are held in a socket insert. The socket connector further includes a socket magnet module. The socket magnet module includes a socket magnet arranged within a socket magnet insert.

The pin contacts may each include a cylindrical mating portion. The cylindrical mating portion of each pin contact engages a corresponding mating portion of a socket contact when the plug connector is inserted into the socket connector. The pin contacts and the receptacle contacts are each capable of conducting an electric current of more than 15 A. In some installations, the contacts may be capable of conducting an electric current of more than 100 A, more than 200 A, and up to 800 A. The pin contacts are electrically insulated from one another to allow for voltages of at least 250 V between respective pin contacts. The same applies to the receptacle contacts, which are electrically insulated from one another to allow for voltages of at least 250 V between respective receptacle contacts. In the context of industrial connectors, the contacts are more preferably capable of supporting voltages of at least 700V.

In some aspects, the plug magnet is secured in the plug magnet insert in an axially fixed position and the socket magnet is slidably arranged in the socket magnet insert and outwardly biased by a spring. Alternatively, the socket magnet is secured in the socket magnet insert in an axially fixed position, and the plug magnet is slidably arranged in the plug magnet insert and outwardly biased by a spring. In yet another aspect, both the plug magnet and the socket magnet may be slidably arranged in their respective magnet inserts and outwardly biased by respective springs.

In some aspects, the plug magnet insert may extend forwardly of an adjacent plug insert, or the socket magnet insert may extend forwardly of an adjacent socket insert.

In some aspects, the plug magnet is configured to slide between an outer plug magnet position and an inner plug magnet position. In the outer plug magnet position a front end of the plug magnet is arranged in front of front ends of the pin contacts. In the inner plug magnet position the front end of the plug magnet is arranged behind the front ends of the pin contacts. Alternatively, the socket magnet is configured to slide between an outer socket magnet position and an inner socket magnet position. In the outer socket magnet position a front end of the socket magnet is arranged in front of front ends of the receptacle contacts. In the inner socket magnet position the front end of the socket magnet is arranged behind the front ends of the receptacle contacts.

In some aspects, a magnetic force between the plug magnet and the socket magnet aids an alignment of the plug connector to the socket connector during assembly, and the magnetic force does not act on the plug connector or the socket connector when the plug connector is fully inserted into the socket connector.

In some aspects, the plug magnet has a forwardly facing magnetic north pole and the socket magnet has a forwardly facing magnetic south pole. Alternatively, the plug magnet has a forwardly facing magnetic south pole and the socket magnet has a forwardly facing magnetic north pole.

In some aspects, the plug magnet module further includes a second plug magnet, and the socket magnet module further includes a second socket magnet.

In some aspects, the plug magnet has a forwardly facing magnetic north pole and the second plug magnet has a forwardly facing magnetic south pole. Correspondingly, the socket magnet has a forwardly facing magnetic south pole and the second socket magnet has a forwardly facing magnetic north pole.

The plug magnet insert and the plug insert may be interchangeable.

In some aspects, the plug magnet insert is sandwiched between two plug inserts, and the socket magnet insert is sandwiched between two socket inserts.

In some aspects, the plug magnet is shorter and wider than the socket magnet.

In some aspects, the plug magnet and the plug magnet insert include matching visual markings when the plug magnet has been inserted into the plug magnet insert in a correct orientation and the plug magnet and the plug magnet insert include mismatching visual markings when the plug magnet has been inserted into the plug magnet insert in an incorrect orientation.

In some aspects, a peak magnetic force pulling the plug connector towards the socket connector during insertion is between 20 N and 60 N.

In some aspects, the peak magnetic force is reached when the plug connector and the socket connector are between 10 mm and 15 mm apart from a fully inserted position.

In some aspects, the techniques described herein relate to an electrical connector, including a contact module. The contact module includes a plurality of contacts arranged in a contact insert. The contact module further includes a magnet module, including a magnet that is slidably arranged within a magnet insert. A compression spring is arranged within the magnet insert behind the magnet and pushes the magnet towards a front of the magnet insert.

In some aspects, the electrical connector further includes a second magnet, slidably arranged within the magnet insert and forwardly biased by a second spring. The magnet and the second magnet each have a cylindrical shape and their longitudinal axes are arranged parallel one another. The magnets may be axially magnetized permanent magnets, and their magnetic fields may be arranged opposite one another.

In some aspects, the techniques described herein relate to an electrical connector system, including the disclosed electrical connector, and a mating electrical connector. The mating electrical connector includes a mating contact module, including a plurality of mating contacts arranged with a mating contact insert and a mating magnet module, including a mating magnet arranged within a mating magnet insert.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows an exploded view of a plug and socket connection system.

FIG. 2 is a perspective view of a plug and socket connection system, in a plugged-in state.

FIG. 3 is a perspective view of a plug and socket connection system in a separated state.

FIG. 4 shows the plug and socket connection system as in FIG. 3 from a different angle.

FIG. 5 is a cross sectional view through the plug and socket connection system as in FIG. 3.

FIG. 6 is a perspective view into the socket connectors of the plug and socket connection system as in FIG. 3.

FIG. 7 is a perspective view into the plug connectors of the plug and socket connection system as in FIG. 3.

FIG. 8 shows a portion of the plug connector as in FIG. 7 without housing.

FIG. 9 shows a force/travel diagram.

FIG. 10 shows a cross sectional view through the socket connector in an alternative configuration.

### DETAILED DESCRIPTION

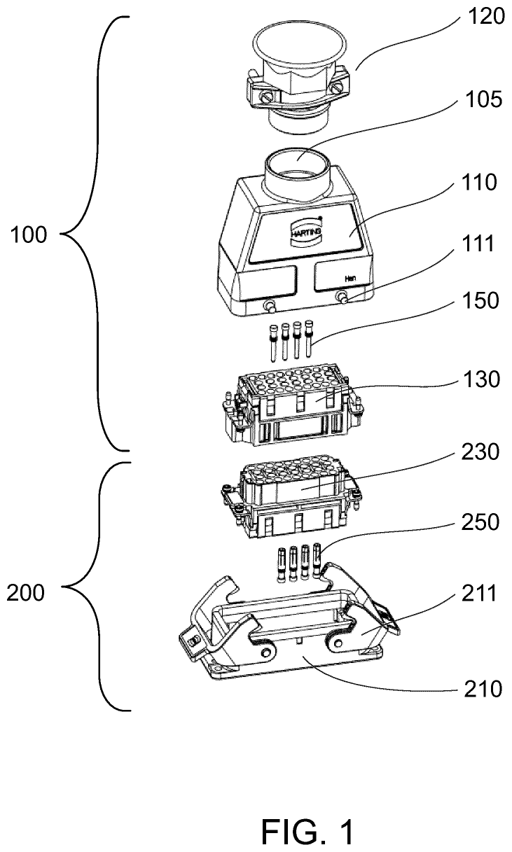

FIG. 1 shows an exploded view of a plug and socket connection system. The system includes a plug connector 100 and a socket connector 200.

The plug connector 100 includes a plurality of pin contacts 150. Pin contacts are sometimes referred to as male contacts. In the context of the present application, they should be more broadly understood to refer to a first type of contacts. When in use, each of the pin contacts 150 is electrically connected to one wire of a cable. Contacts may be in the form of screw terminals, crimp terminals, or cage-clamp terminals. The terms contact and terminal are used interchangeably. The pin contacts 150 are securely held within a plug insert 130. The plug insert 130 is in turn secured within a plug housing 110. The plug housing 110 may also be referred to as a hood. The plug housing 110 includes a cable entry opening 105. The cable entry opening 105 can be arranged for rear entry or side entry of the cable. A cable entry protection 120 may be secured to the cable entry opening 105. The cable entry protection 120 can come in various configurations. The cable entry protection 120 can for example be a universal cable gland, a special cable clamp with strain relief, a bell mouthed cable fitting, or an anti-twist device. A cable gland may include one or multiple seals.

The plug connector 100 is configured to mate with a corresponding socket connector 200. The socket connector 200 includes a plurality of receptacle contacts 250. Receptacle contacts are sometimes referred to as female contacts. In the context of the present application, they should be more broadly understood to refer to a second type of contacts. Each of the receptacle contacts 250 is configured to receive one of the pin contacts 150 to create an electrical connection. The receptacle contacts 250 are securely held within a socket insert 230. The socket insert 230 is secured within a socket housing 210.

The geometries of the plug insert 130 and the socket insert 230 are coordinated such that they can be plugged together. When being plugged together, portions of the plug insert 130 and the socket insert 230 overlap.

A locking mechanism may be provided to lock the plug connector 100 to the socket connector 200. The locking mechanism may include a lever 211 that is pivotally connected to the socket housing 210. The lever 211 may include a recess that engages a locking protrusion 111 of the plug housing 110. When engaged, the lever securely holds the plug connector 100 and the socket connector 200 together. The lever 211 can be pivoted into an unlocked position to disengage the locking protrusion 111 for removing the plug connector 100 from the socket connector 200.

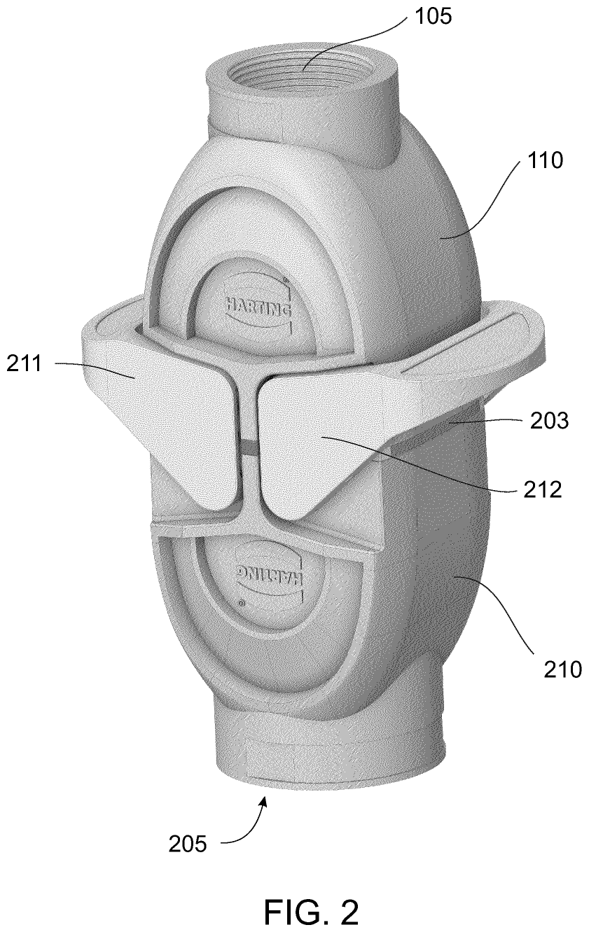

FIG. 1 illustrates an example in which the socket connector 200 is suitable to be permanently fixed to a device as in a chassis connector. FIG. 2 shows an alternative configuration in which the plug housing 110 and the socket housing 210 are alike and both are configured to be connected to a respective cable. Both the plug housing 110 and the socket housing 210 include respective cable entry openings 105, 205. The plug housing 110 is locked to the socket housing 210 by a locking mechanism. The locking mechanism here includes two levers 211, 212. The levers 211, 212 are shown in the locked state. To unlock the plug housing 110 from the socket housing 210 the levers can be pivoted towards the socket connector 200. A seal 203 is arranged between the plug housing 110 and the socket housing 210.

In some applications, the plug connector 100 and the socket connector 200 are out of sight and must be connected in a blind operation. In such applications it can be difficult for an operator to correctly align the plug connector 100 with the socket connector 200 without visual cues.

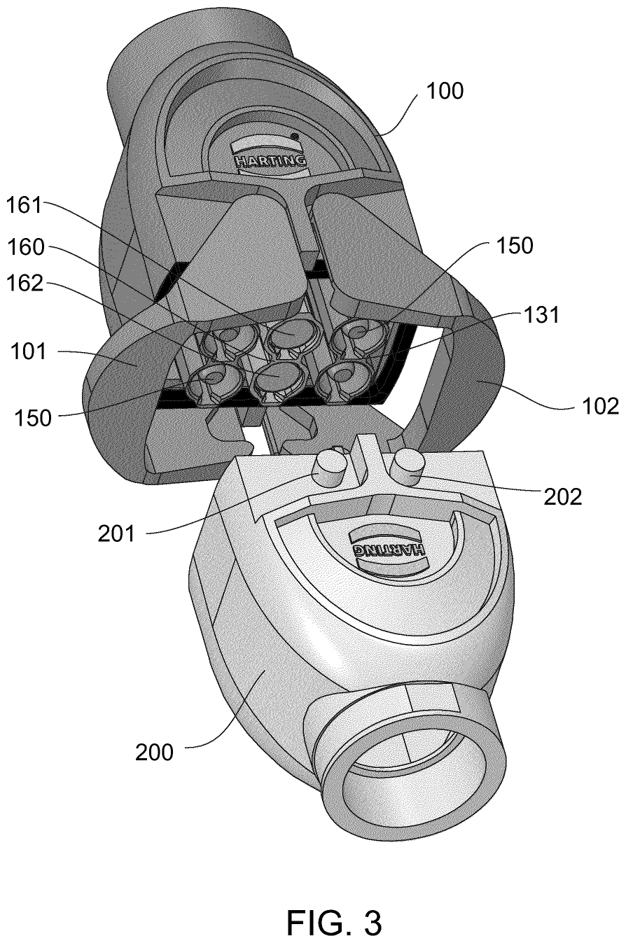

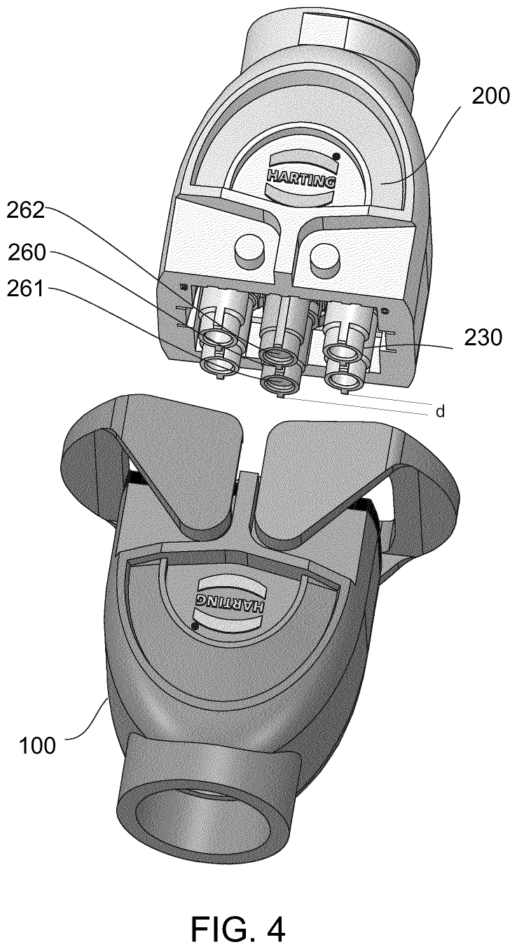

The plug and socket connector system shown in FIGS. 3 and 4 includes a magnetic alignment feature to aid an operator in aligning the plug connector 100 with the socket connector 200 for connecting the two. In particular, the plug connector 100 includes a plug magnet module 160. The plug magnet module 160 includes a plug magnet 161 and a second plug magnet 162.

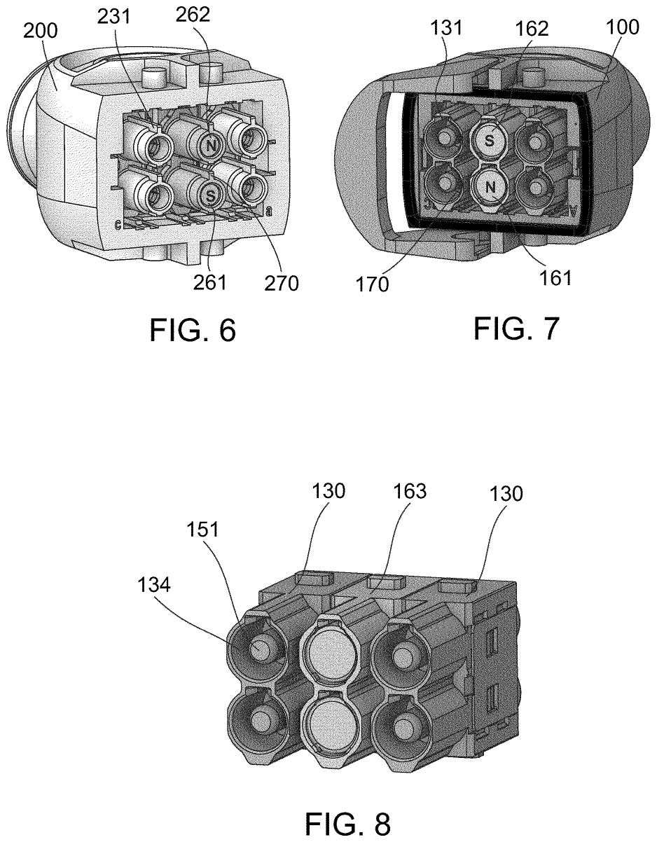

As shown in FIGS. 6 and 7, the plug magnet module 160 of the plug connector 100 cooperates with a socket magnet module 260 in the socket connector 200. The socket magnet module 260 includes a socket magnet 261 and a second socket magnet 262. In the illustrated example, the plug magnet 161 is in a “north out” orientation in which a magnetic north pole of the plug magnet 161 faces outwardly towards the socket connector 200. The second plug magnet 162 is oppositely arranged in a “south out” orientation with a magnetic south pole of the second plug magnet 162 facing the socket connector 200.

Within the socket magnet module 260 the magnets are arranged in opposite orientation to the plug magnet module 160. The socket magnet 261 is in a “south out” orientation so that a magnetic force pulls the socket magnet 261 towards the outwardly facing north pole of the plug magnet 161. At the same time, the second socket magnet 262 is in a “north out” orientation and the second socket magnet 262 is pulled towards the outwardly facing south pole of the second plug magnet 162.

The plug and socket connector system is designed as a modular system. That is, individual components within the system exist in interchangeable variants. The interchangeable variants can be mixed-and-matched to satisfy the needs of a particular application. For example, pin contacts 150 can be distinguished by a type of wire connection as crimp contacts and screw contacts. Yet, both crimp contacts and screw contacts share common mechanical features so that they can be received within the same plug insert 130. Different types of plug inserts 130 can be combined within a plug connector 100.

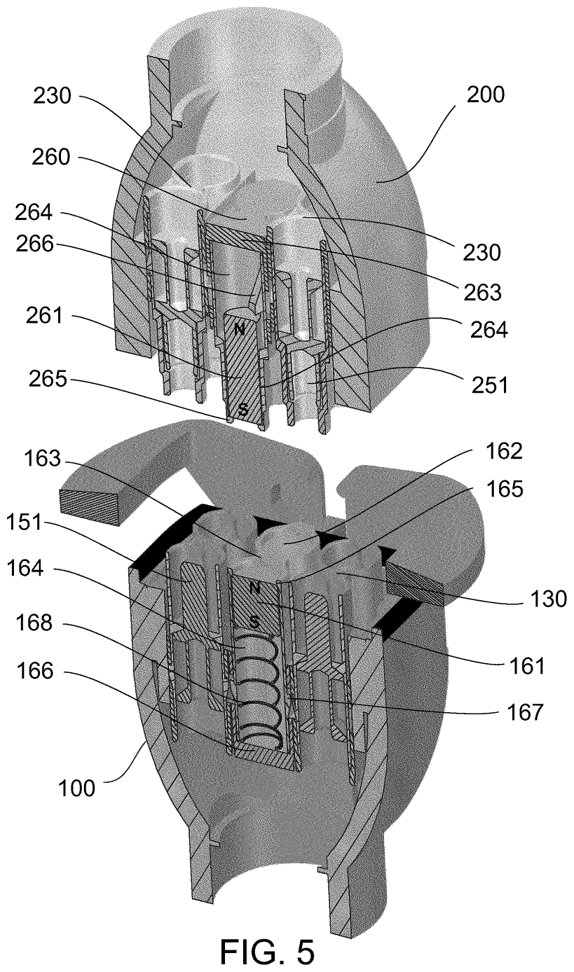

As shown in the cross sectional view of FIG. 5 and the perspective view of FIG. 8, the plug magnet 161 and the second plug magnet 162 are held within a plug magnet insert 163. The plug magnet insert 163 shares a common mechanical interface 167 with the plug insert 130 that holds the pin contacts 150. The illustrated plug connector 100 is configured with two plug inserts 130, each holding two pin contacts 150. The plug magnet module 160 is sandwiched between the two plug inserts 130. In an alternative configuration, the plug connector 100 could be configured as a six-pin connector with three plug inserts 130 by forgoing the magnetic alignment feature.

The modular design equally applies to the socket connector 200. As shown, the socket magnet module 260 is sandwiched between two socket inserts 230.

The magnetic alignment serves to align the plug connector 100 with the socket connector 200 while plugging the two together. The magnetic alignment is not used to retain the plug connector 100 within the socket connector 200 while in use. In combination with industrial connectors that may be rated to carry electric currents of up to 200 A, or even up to 800 A at voltages that exceed 700 V, magnetic force alone would be insufficient to secure the plug connector 100 to the socket connector 200. To secure the plug connector 100 to the socket connector 200 a mechanical locking mechanism is used. The mechanical locking mechanism includes a first locking lever 101 and a second locking lever 102 that are pivotally mounted on the plug housing 110. The locking levers engage corresponding locking pins 201, 202 of the socket connector 200 when in a locked position.

The pin contacts 150 each comprise a cylindrical mating portion 151. The cylindrical mating portion 151 of each pin contact 150 engages a corresponding mating portion 251 of a socket contact 250 when the plug connector 100 is inserted into the socket connector 200. The pin contacts 150 and the receptacle contacts 250 are each capable of conducting an electric current of more than 15 A.

The cylindrical mating portion 151 of each of the pin contacts 150 is surrounded by an insulating generally cylindrical wall 134. The pin contacts 150 are so able to carry voltages greater than 200V, or even greater than 700V. The plug connector 100 may be rated for voltages up to 1 kV. Similarly, the generally hollow cylindrical mating portion 251 of each of the receptacle contacts 250 is surrounded by an insulating generally cylindrical wall 234. The receptacle contacts 250 are so able to carry voltages greater than 200V, or even greater than 700V. The socket connector 200 may be rated for voltages up to 1 kV.

As shown in FIG. 10, the socket magnet module 260 may be arranged flush with adjacent socket inserts 230. A front end of the socket magnet module 260 and front ends of the adjacent socket inserts 230 are arranged in a common plane 235. The socket magnet 261 extends forwardly of the adjacent receptacle contacts 250. As shown in FIG. 4, the socket magnet module 260 may alternatively extend forwardly in front of the adjacent socket inserts 230. FIG. 5 shows that the socket magnet 261 extends forwardly of the adjacent receptacle contacts 250. In this configuration, the socket magnet module 260 forms a forwardmost extension of the socket connector 200.

In both configurations as shown in FIG. 4 and FIG. 10, the plug magnet 161 and the socket magnet 261 make contact before the adjacent pin contacts 150 and receptacle contacts 250 contact each other. When the plug connector 100 moves towards the socket connector 200, the plug magnet module 160 and the socket magnet module 260 are the first parts to make contact. An operator can let the magnetic force between the plug magnet module 160 and the socket magnet module 260 guide the plugging process and let the respective magnets get into contact before any electrical connection between the plug connector 100 and the socket connector 200 is established.

Two magnet pairs with opposite magnetic polarization, one pair on the plug connector 100 and another pair on the socket connector 200, create an attractive force. At the same time, a rotational torque is generated if the plug connector 100 is rotationally misaligned with the socket connector 200. The plug magnet module 160 and the socket magnet module 260 interact to align the plug connector 100 with the socket connector 200 laterally in an x-y plane of the connector and rotationally about a z-axis of the connector. The z-axis here corresponds to the longitudinal axis of the pin contacts 150 and the receptacle contacts 250. The z-axis is also the plug-in direction.

FIG. 5 shows how the socket magnet 261 is securely held within a fixed position in the socket magnet insert 263. The socket magnet 261 has a cylindrical shape and is received in a hollow cylindrical receiving portion 264 of the socket magnet insert 263. At its front end, the socket magnet 261 abuts a stop collar 265 integrally formed in the socket magnet insert 263. At its opposite rear end, the socket magnet 261 abuts a plurality of latching arms 266 which extend radially inwardly into the hollow receiving portion of the socket magnet insert 263. As shown, the socket magnet 261 is held in an axially fixed position. The second socket magnet 262 is mounted in the same way, albeit with an opposite magnetic orientation.

In contrast, the plug magnet 161 is axially displaceable within a cylindrical receiving portion 164 of the plug magnet insert 163. In a frontmost position, the plug magnet 161 abuts a stop collar 165 integrally formed in the plug magnet insert 163.

The plug magnet 161 is shaped as a cylinder having an outer diameter that is slightly smaller than a diameter of the cylindrical receiving portion 164. The plug magnet 161 can slide axially within the cylindrical receiving portion 164. A compression spring 168 is arranged behind the plug magnet 161 so as to bias the plug magnet 161 into a forward position. A rear end of the compression spring 168 is supported on a bottom wall 166 of the plug magnet insert 163. When plugging the plug connector 100 into the socket connector 200, the socket magnet 261 initially contacts the plug magnet 161 while the plug magnet 161 is biased into an outer position by the spring 168.

As the socket connector 200 is pushed into the plug connector 100, the plug magnet 161 slides rearwardly within the cylindrical receiving portion 164 against the compression force of the compression spring 168. The pin contacts 150 and receptacle contacts 250 start engaging each other and forming an electrical connection after the socket magnet insert 263 has been partially inserted into the plug magnet insert 163. At this time, the plug magnet 161 has been partially displaced inwardly of its outer position.

Once the plug connector 100 is fully inserted into the socket connector 200, the plug magnet 161 is arranged in an inner position. At this time, the first locking lever 101 and the second locking lever 102 can be pivoted to lock the plug connector 100 to the socket connector 200.

As a consequence of this design, a magnetic force guides insertion of the plug connector 100 into the socket connector 200 only until the plug magnet 161 reaches the socket magnet 261. The magnetic force subsides before the respective electrical contacts touch each other. Once the plug magnet 161 abuts the second socket magnet 262, no magnetic force acts on the plug connector 100 or the socket connector 200. The plug magnet 161 is still pulled towards the socket magnet 261. Due to the sliding arrangement of the plug magnet 161 in the cylindrical receiving portion 164 of the plug magnet insert 163, the magnetic force does not transfer into the plug connector 100. Rather, the compression spring 168 generates a slight force pushing the plug connector 100 away from the socket connector 200.

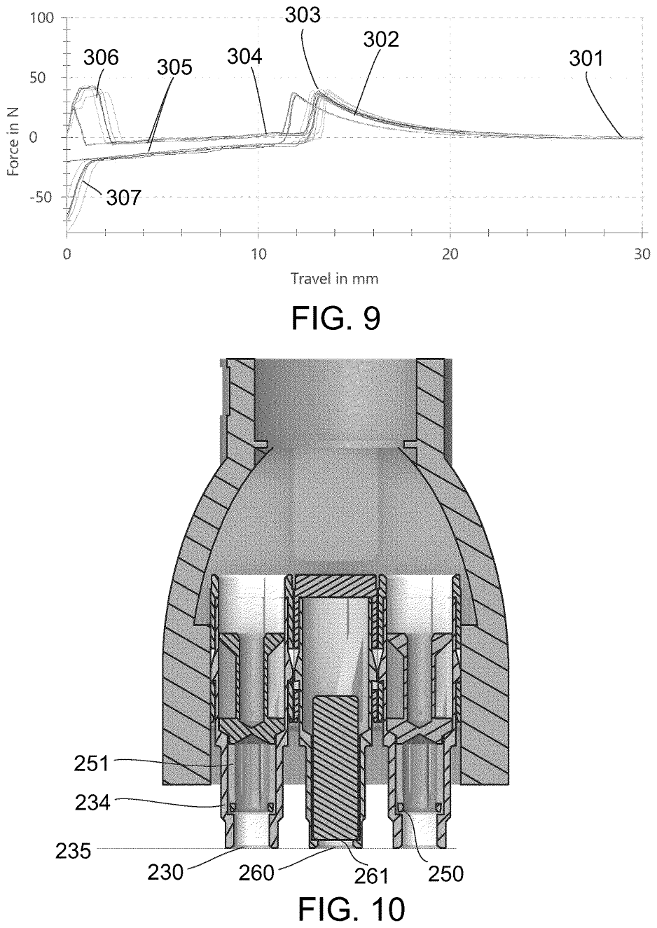

FIG. 9 shows test results of several plugging and unplugging operations. Plugging operations are shown by initially negative lines 307, unplugging operations are shown by initially positive lines 306. The graph illustrates a force over the travel distance. A positive force represents a pulling force being applied; a negative force represents a pushing force. Initially, the plug connector 100 and the socket connector 200 are 30 mm apart. At that distance, no appreciable magnetic force 301 can be measured. The magnetic force 302 increases as the plug connector 100 and socket connector 200 come closer. The magnetic force peaks just before the plug magnet 161 reaches the socket magnet 261. At its peak, the magnetic force 303 amounts to about 40 to 60 N. At this point, the plug connector 100 is still approximately 10-15 mm away from its fully inserted position within the socket connector 200. Once the plug magnet 161 abuts the socket magnet 261, the magnetic force 304 becomes zero. During further insertion, a spring force 305 can be observed that is directed against the insertion direction of the plug connector 100 into the socket connector 200. The spring force 305 is relatively small and does not exceed 10 N in the illustrated example.

The plug magnet module 160 and the socket magnet module 260 are preferably mechanically keyed to ensure that the plug connector 100 and the socket connector 200 can be plugged together only if properly aligned. For this purpose, the socket magnet module 260 includes a web 270 which slides into a corresponding groove 170 of the plug magnet module 160. The groove 170 includes an outer funnel-shaped opening to receive and guide the web 270 during insertion.

In an advantageous embodiment, the socket magnet 261 is an axially magnetized neodymium magnet (NdFeB magnet) with a nickel-copper-nickel (NiCuNi) plating. The socket magnet 261 may have a diameter of 8 mm (±3 mm) and a length of 25 mm (±10 mm). The socket magnet 261 may have a residual induction BRₘₐₓ of 13200 Gauss (±35%) and a maximum energy product BHₘₐₓ of 42 MGOe (±35%). The plug magnet 161 may be made of the same material and have the same magnetic characteristics as the second socket magnet 262. That is, the plug magnet 161 also has a residual induction BRₘₐₓ of 13200 Gauss (+35%) and a maximum energy product BHₘₐₓ of 42 MGOe (±35%). The plug magnet 161 may have a diameter of 11 mm (+4 mm) and a length of 12.5 mm (±5 mm).

During connector assembly, prior to use, it is important to correctly orient the magnetic field of the socket magnet 261 and the plug magnet 161. The magnetic fields of the respective magnets must be coordinated with a mechanical keying of the connectors. In FIG. 6 a mechanical key 231 of the socket insert 230 faces upwardly. This corresponds to a “north out” orientation of the upper second socket magnet 262. In FIG. 7 the corresponding mechanical key 131 of the plug insert 130 also faces upwardly. By convention, the second plug magnet 162 is in a “south out” orientation. To facilitate assembly and correct orientation the magnets are visually marked. The visual marking may be in form of color coding or printed or etched letters on the magnet. The plug magnet insert 163 and socket magnet insert 263 may include corresponding markings, e.g., color coding or letters to easily recognize in which orientation a magnet is to be inserted. Matching letters, color codes, or other visual cues between the magnet and the magnet insert also support inspection and quality control.

Generally speaking, the slidingly arranged plug magnet 161 and the fixedly arranged socket magnet 261 preferably have the same residual induction BRₘₐₓ and the same maximum energy product BHₘₐₓ. The sliding plug magnet 161 is however shorter and wider than the fixed socket magnet 261.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements that are included within the spirit and scope of the following claims.

What is claimed is:

1. A connector system, comprising:
a plug connector (100), comprising
a plurality of pin contacts (150), the pin contacts (150) being held in a plug insert (130), and
a plug magnet module (160), comprising
a plug magnet (161) arranged within
a plug magnet insert (163); and
a socket connector (200), comprising
a plurality of receptacle contacts (250), the receptacle contacts (250) being held in a socket insert (230), and
a socket magnet module (260), comprising
a socket magnet (261) arranged within
a socket magnet insert (263).

2. The connector system as in claim 1,
wherein the pin contacts (150) each comprise a cylindrical mating portion (151),
wherein the cylindrical mating portion (151) of each pin contact (150) engages a corresponding mating portion (251) of a socket contact (250) when the plug connector (100) is inserted into the socket connector (200), and
wherein the pin contacts (150) and the receptacle contacts (250) are each capable of carrying voltages of at least 700 V.

3. The connector system as in claim 1,
wherein the plug magnet (161) is secured in the plug magnet insert (163) in an axially fixed position and the socket magnet (261) is slidably arranged in the socket magnet insert (263) and outwardly biased by a spring (168), or
wherein the socket magnet (261) is secured in the socket magnet insert (263) in an axially fixed position and the plug magnet (161) is slidably arranged in the plug magnet insert (163) and outwardly biased by a spring.

4. The connector system as in claim 1,
wherein the plug magnet insert (163) extends forwardly of an adjacent plug insert (130), or
wherein the socket magnet insert (263) extends forwardly of an adjacent socket insert (230).

5. The connector system as in claim 1,
wherein the plug magnet (161) is configured to slide between
an outer plug magnet position, in which a front end of the plug magnet is arranged in front of front ends of the pin contacts, and
an inner plug magnet position, in which the front end of the plug magnet is arranged behind the front ends of the pin contacts, or
wherein the socket magnet (261) is configured to slide between
an outer socket magnet position, in which a front end of the socket magnet is arranged in front of front ends of the receptacle contacts, and
an inner socket magnet position, in which the front end of the socket magnet is arranged behind the front ends of the receptacle contacts.

6. The connector system as in claim 1,
wherein a magnetic force between the plug magnet and the socket magnet aids an alignment of the plug connector (100) to the socket connector (200) during assembly, and
wherein the magnetic force does not act on the plug connector (100) or the socket connector (200) when the plug connector (100) is fully inserted into the socket connector (200).

7. The connector system, as in claim 1,
wherein the plug magnet (161) has a forwardly facing magnetic north pole and the socket magnet (261) has a forwardly facing magnetic south pole, or
wherein the plug magnet (161) has a forwardly facing magnetic south pole and the socket magnet (261) has a forwardly facing magnetic north pole.

8. The connector system, as in claim 1,
wherein the plug magnet module (160) further comprises a second plug magnet (162), and
wherein the socket magnet module (260) further comprises a second socket magnet (262).

9. The connector system, as in claim 8,
wherein the plug magnet (161) has a forwardly facing magnetic north pole and the second plug magnet (162) has a forwardly facing magnetic south pole, and
wherein the socket magnet (261) has a forwardly facing magnetic south pole and the second socket magnet (262) has a forwardly facing magnetic north pole.

10. The connector system, as in claim 1,
wherein the plug magnet insert (163) and the plug insert (130) are interchangeable.

11. The connector system, as in claim 1,
wherein the plug magnet insert (163) is sandwiched between two plug inserts (130) and
wherein the socket magnet insert (263) is sandwiched between two socket inserts (230).

12. The connector system, as in claim 1,
wherein the plug magnet (161) is shorter and wider than the socket magnet (261).

13. The connector system, as in claim 1,
wherein the plug magnet (161) and the plug magnet insert (163) include matching visual markings when the plug magnet (161) has been inserted into the plug magnet insert (163) in a correct orientation, and
wherein the plug magnet (161) and the plug magnet insert (163) include mismatching visual markings when the plug magnet (161) has been inserted into the plug magnet insert (163) in an incorrect orientation.

14. The connector system, as in claim 1,
wherein a peak magnetic force pulling the plug connector (100) towards the socket connector (200) during insertion is between 20 N and 60 N.

15. The connector system, as in claim 14,
wherein the peak magnetic force is reached when the plug connector (100) and the socket connector (200) are between 10 mm and 15 mm apart from a fully inserted position.

16. An electrical connector, comprising:
a contact module, comprising
a plurality of contacts (150) arranged within
a contact insert (130); and
a magnet module (160), comprising
a magnet (161), slidably arranged within
a magnet insert (163), and
a spring arranged within the magnet insert (163) behind the magnet (161) and configured to push the magnet (161) towards a front of the magnet insert (163).

17. The electrical connector as in claim 16, further comprising:
a second magnet (162), slidably arranged within the magnet insert (163) and forwardly biased by a second spring,
wherein the magnet (161) and the second magnet (162) each have a cylindrical shape,
wherein a longitudinal axis of the magnet (161) and a longitudinal axis of the second magnet (162) are parallel, and
wherein the magnet (161) and the second magnet (162) are axially magnetized permanent magnets, and
wherein a magnetic field of the magnet (161) and a magnetic field of the second magnet are opposite.

18. An electrical connector system, comprising:
the electrical connector as in claim 17, and
a mating electrical connector, the mating electrical connector comprising:
a mating contact module, comprising
a plurality of mating contacts (250) arranged within
a mating contact insert (230); and
a mating magnet module (260), comprising
a mating magnet (261), arranged within
a mating magnet insert (263).
